(19) United States
(12) Patent Application Publication
(10) Pub. No.: US 2011/0214989 A1
(43) Pub. Date: Sep. 8, 2011

(54) SENSOR ELEMENT HAVING A CARRIER ELEMENT

(76) Inventors: Andreas Opp, Rutesheim (DE); Hans-Joerg Renz, Leinfelden-Echterdingen (DE)

(21) Appl. No.: 13/129,956

(22) PCT Filed: Nov. 17, 2009
(86) PCT No.: PCT/EP09/65268

§ 371 Date: May 18, 2011

(30) Foreign Application Priority Data
Nov. 20, 2008 (DE) 10-2008-043-932.0

(51) Int. Cl. G01N 27/407

(52) U.S. Cl. 204/424

(57) ABSTRACT

A sensor element for determining at least one property of a gas in a measuring gas chamber, in particular for detecting a gas component in a gas mixture. The sensor element includes at least one cell having at least one first electrode, at least one second electrode and at least one solid electrolyte connecting the first electrode and the second electrode having a solid electrolyte material. The sensor element further includes at least one carrier element made of a carrier material, the carrier material having a lower ionic conductivity than the solid electrolyte material. The carrier element is configured and situated to confer mechanical stability on the cell.

### FIELD OF THE INVENTION

The present invention is directed to known ceramic sensor elements, in particular sensor elements which operate based on electrolytic properties of certain solids, specifically the capacity of these solids to conduct certain ions. Sensor elements of this type are in particular utilized in motor vehicles. As an important example of ceramic sensor elements in motor vehicles, reference may be made to those that are used to determine the composition of an air-fuel mixture, these also being called “lambda sensors” and playing an important role in the reduction of pollutants in exhaust gases, both in spark ignition and in compression ignition engines. However, the present invention is also applicable to other types of ceramic sensor elements, for example to particle sensors or similar types of sensors having solid electrolytes, in particular in exhaust gas sensor systems. Without limiting the scope of protection, the present invention is described below using the example of lambda sensors, although, as recited above, other types of sensor elements may also be manufactured.

### BACKGROUND INFORMATION

The air/fuel ratio known as “lambda” (A) is generally used in combustion engineering to designate the ratio between a mass of air actually available and the mass of air theoretically needed for combustion (i.e., the stoichiometric mass of air). In this process, the air/fuel ratio is measured with the aid of one or more sensor elements generally at one or more or places in the exhaust system of an internal combustion engine. Accordingly, “rich” gas mixtures (in other words, gas mixtures having an excess of fuel) have an air/fuel ratio λ<1, whereas “lean” gas mixtures (in other words, gas mixtures having a deficit of fuel) have an air/fuel ratio λ>1. In addition to motor vehicles, these and similar sensor elements are also used in other branches of engineering (in particular combustion engineering), for example in aviation engineering or in the regulation of burners, for example in heating plants or power stations.

Lambda sensors are known from the related art in numerous different specific embodiments. A first specific embodiment is represented by the so-called discrete-level sensor, the operating principle of which is based on measurement of an electrochemical difference in potential between a reference gas and the gas mixture to be analyzed. The reference electrode and the measuring electrode are connected together by the solid electrolyte. Owing to their good oxygen ion-conductive characteristics, generally speaking zirconium dioxide (e.g., yttrium-stabilized zirconium dioxide, YSZ) or similar ceramics are used for the solid electrolyte. As an alternative or in addition to discrete-level sensors, so-called pumping cells are also used, in which an electrical pumping voltage is applied to two electrodes joined together by the solid electrolyte and the pumping current is measured by the pumping cell. The described sensing principles of discrete-level cells and pumping cells may also be advantageously utilized in combination in so-called multi-cell devices, in particular in broadband lambda sensors. Various exemplary embodiments of lambda sensors that may also be modified according to the present invention within the scope of the present invention are discussed in “Sensoren im Kraftfahrzeug” (Sensors in motor vehicles), 2nd edition, Robert Bosch GmbH, April 2007, pp. 154-159.

With such sensor elements, however, for example sensor elements of the type discussed above, the selection of the material, and in particular the selection of the material for the solid electrolyte, in many cases represents a compromise. For example, on the one hand severe demands are placed on the electrolytic properties of the material for the solid electrolyte. The material in particular needs to have a high conductivity, for example, for ions of the gas component that is to be detected. Such an ionic conductivity is generally achieved with the aid of lattice voids, for example oxide ion voids in a metal oxide lattice. In order to create these oxide ion voids, generally speaking doping is used. In this process, a doping material is added to the metal oxide of the matrix material of a solid electrolyte, and occupies lattice sites of the metal oxide, but creates oxygen voids as a result of having a different valency from the metal of the metal oxide of the matrix material. These oxygen voids may, for example, create conductivity for oxygen ions. A typical example of this kind of doping involves zirconium dioxide which is doped with an oxide of a lower-valency metal. Usually, yttrium oxide is used for this doping. Thus yttrium-stabilized zirconium dioxide is most usually used in lambda sensors as the material for the solid electrolyte.

At the same time, however, in conventional oxygen sensors the solid electrolyte, in addition to its function as the electrolyte, also has the function of a carrier material. This however places high demands on this material with regard to mechanical stability and resistance to thermal shock. Since the mechanical strength and load-bearing capacity of conventional solid electrolyte materials diminishes, however, with increasing doping and the resultant rising ionic conductivity, these two objectives are in conflict.

A further technical challenge related to the problems described above is the elimination of leakage currents. Since because of the requirement for mechanical stability doping cannot be increased without limitation, and since nevertheless a stipulated ionic conductivity must be achieved for the sensor elements to operate, in many cases the sensor elements are operated at elevated temperatures. In order to make this possible, as an example, heating elements are used. However, it is then possible under certain conditions, in particular at higher temperatures, for the ionic conductivity to cause harmful leakage currents to occur in the sensor element, for example between the electrodes of the sensor element and the heating element. For this reason, generally speaking, both the heating element and also the electrodes are provided with complex insulation in the areas not needed for the operation of the sensor element. Where layered structures are used, generally speaking feedthroughs to tracks located on lower layers are also provided with complex insulation in this manner. Despite the high level of complexity involved in making insulating layers, generally speaking, rejects occur during manufacture of the sensor elements, as a result of high leakage currents.

### SUMMARY OF THE INVENTION

Consequently, a sensor element is proposed for determining at least one property of a gas in a measuring gas chamber, which at least to a large extent avoids the set of problems described above and at least to a large extent resolves the conflict of objectives described. The sensor element may in particular be set up to demonstrate the presence of a component of a gas mixture, for example to demonstrate the presence of oxygen. The sensor element may in particular be set up in order to determine the composition of the exhaust gas in the exhaust system of an internal combustion engine. In this connection reference may be made, for example, to the specific embodiments known from related art and described above, which may be modified according to the present invention. Other embodiments and/or applications, however, are also possible in principle, for example detection of the presence of other types of gas components and/or use as a particle counter.

A fundamental aspect of the exemplary embodiments and/or exemplary methods of the present invention is to separate the functionality of mechanical stabilization and carrier function from that of ionic conductivity, so that these may be optimized in isolation from each other. By way of this separation into the functions of mechanical stability and ionic conductivity, optimization may thus be achieved with regard on the one hand to the ionic conductivity desired at certain points and undesired at other points, and on the other hand to the mechanical carrier function.

The proposed sensor element accordingly includes at least one cell having at least one first electrode, at least one second electrode, and at least one solid electrolyte which joins the first electrode and the second electrode together and is made of a solid electrolyte material. Here, the sensor element may be a single-cell or a multiple-cell sensor element; once again reference is made to the description above. The sensor element may thus, for example, include a simple discrete-level cell or a simple single-cell broadband sensor structure or may also be of a more complex design, for example in line with the known broadband sensors having an additional reference electrode, as described above. Here, one, several, or all cells of the sensor element may be of a configuration according to the exemplary embodiments and/or exemplary methods of the present invention, a cell in this case being understood as a combination of at least two of the electrodes present and at least one solid electrolyte joining these electrodes together. Furthermore, electrodes may generally also be of a multi-part design.

Furthermore, the sensor element includes at least one carrier element made of a carrier material. This carrier material has a lower ionic conductivity than the solid electrolyte material. For example, at ambient temperature and/or at temperatures between ambient and 300° C. and/or at temperatures between 300° C. and 600° C. and/or at temperatures between 600° C. and 1000° C., the carrier material may have an ionic conductivity lower by at least a factor of 2, which may be by at least a factor of 10 and in particular may be by at least a factor of 100 than the solid electrolyte material.

The carrier element is situated in order to perform a carrier function, i.e., in order to mechanically stabilize the at least one cell. Here, “mechanical stabilization” is to be understood as a function in which the cell, in particular the material of the cell's solid electrolyte, is relieved during the occurrence of the mechanical stresses that are habitual in the operation of the sensor element, for example bending stresses, tensile stresses or compressive stresses or combinations of such stresses and/or of other types of stress. Specifically, this relief may occur in such a manner that the cell and the carrier element together form a cantilevered element, which may also be combined with further components of the sensor element. The mechanical stabilization may, for example, be achieved by having the carrier element partially or completely surrounding the cell, in particular the solid electrolyte or the solid electrolyte material. This may be achieved, for example, by having the carrier element form an open or closed frame, into which the cell and/or its solid electrolyte is/are partially or completely inserted. This frame may include a single insertion opening or several insertion openings, into which the cell or the solid electrolyte may be inserted. Various specific embodiments are explained in greater detail below.

Specifically, the solid electrolyte material, as described above, may be and/or include a ceramic solid electrolyte material. Also the carrier material may include a ceramic material, which offers the special advantage that use may be made of a shared production process for the ceramic materials. The carrier material, as described above, has a lower ionic conductivity than the solid electrolyte material. The carrier material may also have a lower electronic conductivity than the solid electrolyte material. The solid electrolyte material may be an electronic insulator. The carrier material may especially be electronically insulating. The carrier material may also be ionically insulating. Thus the carrier material may, for example, include at least one ceramic insulating material, where “ceramic insulating material” may be understood as a material which acts as an insulator with regard both to ionic conductivity and to electronic conductivity. Thus the ceramic insulating material may, for example, include an aluminum oxide, in particular Al₂O₃. Alternatively or additionally, however, other types of insulating materials, in particular ceramic insulating materials, may also be used.

The carrier material may be designed to act as an insulator with regard to ionic conductivity, in other words may, itself, have no ionic conductivity. Fundamentally, however, the carrier material itself may also demonstrate ion-conducting properties, which, however, are less marked than the ion-conducting properties of the solid electrolyte material. Thus the carrier material may, for example, contain at least one second solid electrolyte material, having a lower ionic conductivity than the solid electrolyte material. This is, technically, comparatively simple to accomplish, for example by using at least partially identical matrix materials, for example metal oxides, for the material of the solid electrolyte and the second solid electrolyte material of the carrier material. For example, zirconium dioxide may be used both for the solid electrolyte material and also for the second solid electrolyte material. This offers the advantage that the manufacturing process for the sensor element may be designed to be more reliable, since the solid electrolyte material and the second solid electrolyte material may essentially be compatible, for example with regard to thermal expansion. The solid electrolyte material and the second solid electrolyte material may then, for example, be different with regard to doping, which will have a significant impact on the ionic conductivity. Thus, for example, the second solid electrolyte material of the carrier material may receive a considerably lesser degree of doping than the material of the solid electrolyte. In that process, for example, the same combination of doping materials may be used for the solid electrolyte material and the second solid electrolyte material, or different types of doping materials may be used, in order to create the different levels of ionic conductivity in the solid electrolyte material and the second solid electrolyte material. For example, yttrium may be used as the doping material for the solid electrolyte material and/or the second solid electrolyte material, for example in the form of yttrium oxide. For example, Y₂O₃ may be used. Alternatively or additionally, other doping materials may also be used, which may include oxides of a divalent and/or trivalent element, in particular a metal.

For the solid electrolyte material and also if necessary, although this is a less preferred solution, for the second solid electrolyte material, one or more of the following doping materials, for example, may be used: scandium, in particular Sc₂O₃, erbium, ytterbium, yttrium, calcium, lanthanum, gadolinium, europium or dysprosium. The second solid electrolyte material may, however, which may be used in a completely undoped form. For example, a zirconium oxide, for example zirconium dioxide, may be used for the solid electrolyte material, together with, as an example, one or more of the doping materials listed. The carrier material may then, for example, be zirconium dioxide that is undoped and/or has only been doped to a much lesser degree.

The use of scandium, in particular in the form of Sc₂O₃, is in particular may be used as the doping material for the solid electrolyte material, since scandium-doped matrix materials, in particular scandium-doped zirconium dioxide, have a high ionic conductivity, higher for example than yttrium-doped zirconium dioxide. Various embodiments are conceivable.

As described above, there are several possibilities for designing the carrier element in such a way that it may exercise its mechanical stabilizing function in relation to the at least one cell. Thus, for example the possibility exists to design the carrier element wholly or partly as a frame, with the possibility also for this frame to be either completely closed or alternatively partially open. Here, a frame is understood to be, for example, a flat element, possibly disk-shaped or plate-shaped, fundamentally of any desired external shape, such as round, polygonal or rectangular, in which at least one orifice, for which a through orifice has been made. This frame surrounds the at least one cell, in particular the solid electrolyte of this at least one cell, at least partially.

Alternatively or additionally, however, the carrier element may also completely or partially take the form of a carrier layer, which, for example, may be continuous and without orifices. The at least one cell may then be placed on the carrier layer of the carrier element either directly or indirectly, with such indirect placement involving interpolation of one or more intermediate layers. This placement may be done using normal layer-handling techniques. For example, board-printing techniques may be used here. The cells may be placed on one side or both sides of the carrier layer, with single-side placement being preferred for reasons of easier manufacturing.

The carrier layer may be of a cantilever design, conferring on the sensor element, and in particular the cell, cantilevered mechanical stability. The carrier layer may also have at least one orifice, which may be a plurality of orifices. These orifices may penetrate part-way or completely through the carrier layer. In this case, the solid electrolyte material of the at least one cell or, if several solid electrolyte materials are to be used, at least one of these solid electrolyte materials, may be placed at least partially in the at least one orifice. This may be done, for example, in the form of a lattice, with the carrier element having a plurality of orifices that all together form a lattice of holes or of orifices. In this case, the orifices may be disposed regularly or irregularly. The solid electrolyte material may then be placed in these orifices, so that the orifices, together with the solid electrolyte material placed in them, form “islands” which, together with at least two electrodes, may each form a part of a cell or a full cell. In this design, several of these “islands” may each be equipped with their own electrodes, or alternatively one or several shared electrodes may be provided to create the connection between these islands. Various other embodiments are conceivable.

The sensor element may be manufactured in layers, and may have at least two levels of layers. Levels of layers are to be understood as levels into which different materials are introduced. In this case, at least one electrical feedthrough may be provided, with the electrical feedthrough preferably penetrating through the carrier element. By contrast with habitual structures, in which these feedthroughs pass through solid electrolyte layers, in this proposed specific embodiment, the at least one feedthrough thus pass not through the solid electrolyte of the cell, but through the carrier material. Since this carrier material has lower ionic conductivity and may also lower electronic conductivity than the solid electrolyte material of the at least one cell, in this specific embodiment the effort for insulating the feedthroughs may be considerably simplified.

The proposed sensor element in one or more of the specific embodiments described above has considerable advantages by comparison with conventional sensor elements. Thus, for example, a material having a higher ionic conductivity than the surrounding carrier material, in particular a supporting ceramic material, may be introduced as the solid electrolyte material into the area of the actual cell. This makes it possible to optimize separately both the function of mechanical stability and that of ionic conductivity, since different materials may be used for the solid electrolyte material and the carrier material.

A further advantage is that the temperature needed for the operation of the sensor element may be reduced. This results in particular from the fact that the ionic conductivity of the at least one cell required to take measurements may be improved by way of optimization of the solid electrolyte material and may be achieved at considerably lower temperatures. The ion-conductive solid electrolyte material may demonstrate adequate functionality even at these lower temperatures. Consequently, a heating element, which may optionally be provided, may thus be completely omitted. This is advantageous in particular for cost-effective sensor element applications, for example in the field of sensor elements for motorcycles, in which only the heat given off by the exhaust gas may be used to heat up the sensor element and is sufficient to make the sensor element functional.

At the same time, however, the conflict of objectives described above, in which merely using a higher level of doping of the solid electrolyte material results in a reduction in the stability of the solid electrolyte material, may be eliminated. Thus, although measuring capability may be achieved even at markedly lower temperatures with the aid of the higher level of doping, nevertheless an increased resistance to thermal shock and/or mechanical stresses may be achieved, since the carrier element may provide those requisite properties. Since in addition, the sensor element may be operated at lower temperatures, thermal shocks occur moreover to a lesser degree, because for example the sensor element may be operated in a temperature range in which a drop of water touching it could not yet result in a critical temperature drop and a consequent critical temperature shock. For example, the sensor element may be operated in a temperature range below 400° C.

The carrier element may, as described above, include, for example, an insulating ceramic material such as aluminum oxide. Owing to the insulating effect of the substrate ceramic material of the carrier element, insulation of the heating element, of the electrodes and of the feedthroughs, for example, normally placed by means of serigraphy, may be reduced or made much less complex. This may lead to a marked saving in costs by way of a significant reduction in the printing steps and an increase in quality.

For sensor elements such as for example an unheated motorcycle sensor, this may mean that a sensor element based on an insulating ceramic material, for example aluminum oxide, having improved solid electrolyte material, for example as an inlay, and at the same time, adequate stability, would be operational even at lower temperatures. By comparison with sensor elements and material systems used heretofore, for example zirconium oxide doped exclusively with Y₂O₃, on the one hand considerable simplifications in the structure of the sensor element may be achieved thereby and on the other hand savings and/or simplifications in operation may also be attained. For example, as explained above, a heating element may be completely eliminated and/or simpler heating elements or ones operating at lower temperatures may be used.

The structure of the sensor element may for example, apart from the modifications described above, essentially be similar to a known structure of sensor elements. For example, sensor elements may have an external electrode, which is exposed to the gas or gas mixture either directly or after the gas has passed through a protective layer. An internal electrode may then be provided in a layer situated further down, with the outer electrode and the inner electrode being linked by the at least one solid electrolyte. In addition at least one reference electrode may be provided, as is the case, for example, with multiple-cell broadband sensors, for example according to the related art cited above.

For example, an inlay made of ion-conductive solid electrolyte material may be introduced into the area of a cell formed by the reference electrode and the outer electrode. This inlay made of the solid electrolyte material may be placed in and/or on an ionically and may also electronically non-conductive ceramic substrate. This may be done, for example, as described above, by the carrier element's having, for example, an orifice, for example in the form of a recess and/or a stamping. The solid electrolyte material may then be introduced into this orifice, for example in the form of a continuous layer, for example as a continuous piece of a foil. The rest of the sensor element may then be constructed in the usual way, for example using a reference electrode lying inside and an outer electrode placed on the outside.

Alternatively or additionally, as described above, the carrier element may completely or partially take the form of a carrier layer. A piece of a foil of a solid electrolyte material may then be placed on this carrier layer, for example by means of laminating. One advantage of this structure is that the ion-conductive layer of the solid electrolyte material is situated above the carrier material, with the result that here the outer electrode and the reference electrode are situated on top of the carrier layer without a feedthrough. This allows the construction of the layers to be considerably simplified.

On the other hand, as an alternative or in addition, an improved mechanical anchoring and a greater stability of the sensor element may be achieved with the aid of the lattice structure described above, which may also be referred to as a network. Thus the solid electrolyte material, which may have high ion-conductive properties, may be placed into a network of orifices, which thereby take the form of filled bore holes. The filled area may then ensure a sufficiently high ionic conductivity. Also in this case, for example, a structure with at least one electrode lying inside and at least one electrode lying outside may be used.

In all of the described variants of the method it is also possible to make use of at least one reference air duct. For example, such a reference air duct may be in the form of a printed duct, with a reference electrode being linked to a reference air duct containing a porous material. Open reference air ducts are also conceivable.

By the use of an insulating carrier material, for example an insulating ceramic material, one, several, or all customarily used insulating layers may be eliminated. In so doing, it should be ensured that the conductivity of the carrier material, in particular the substrate ceramic material, is sufficiently low for all the earlier requirements with regard to leakage currents to be met. For example, this may be guaranteed with the use of an aluminum oxide foil of appropriate purity as the carrier material.

In order to achieve a sufficiently high mechanical strength, instead of using pure aluminum oxide, in particular a substrate, for the carrier material, an additional possibility is also to use a variant in which the aluminum oxide has zirconium oxide added to it. Thus, for example, Al₂O₃ may have ZrO₂ added to it up to just below the percolation limit. In this way, even better mechanical characteristics of the sensor element may be achieved.

As described above, in particular doped zirconium oxide may be used for the solid electrolyte material. The use of scandium or an oxide of scandium as the doping material is particularly preferred. However, as described above, in principle also other types of doping materials may alternatively or additionally be used. Fundamentally, therefore, as an example materials having a high oxygen conductivity may be used as solid electrolyte materials, where such materials are compatible with the carrier material. Since the carrier material itself now generally speaking only has to carry out mechanical functions, for example a partially stabilized zirconium oxide having a low level of doping may be used as this carrier material, such a material having markedly better mechanical characteristics than the substrate material used heretofore. Overall, in this way sensor elements may be manufactured which are markedly different from known sensor elements, both with regard to their electrical properties and thus their functionality as a sensor element and also with regard to their mechanical and/or thermo-mechanical properties and load-bearing capacity.

Exemplary embodiments of the invention are shown in the drawing and explained in greater detail in the following description.

### BRIEF DESCRIPTION OF THE DRAWINGS

FIG. 1A shows a schematic cross-sectional representation of a first exemplary embodiment of a sensor element according to the present invention.

FIG. 1B shows a representation in perspective of the sensor element as shown in FIG. 1A.

FIG. 2 shows a representation, similar to FIG. 1A, of a second exemplary embodiment of a sensor element according to the present invention.

FIG. 3A shows a representation, similar to FIG. 1A, of a third exemplary embodiment of a sensor element according to the present invention.

FIG. 3B shows a representation in perspective of the sensor element as shown in FIG. 3A.

### DETAILED DESCRIPTION

The exemplary embodiments illustrate three different specific embodiments of sensor elements 110, which are set up in order to determine at least one property of a gas in a measuring gas chamber 112, for example a physical and/or chemical property. Without limitation of other possible applications and embodiments, the invention is described below with reference to lambda sensors which are set up to determine the composition of the exhaust gas in the exhaust system of an internal combustion engine, and thus in particular the oxygen content of the exhaust gas in this exhaust system. Furthermore, sensor elements 110 are shown only in a simple single-cell structure. As described above, however, more complex structures of sensor elements 110 are also possible, such as structures containing several cells. In this context, reference may be made to related art. The modification according to the present invention of such more complex sensor elements 110 will be completely clear to those skilled in the art.

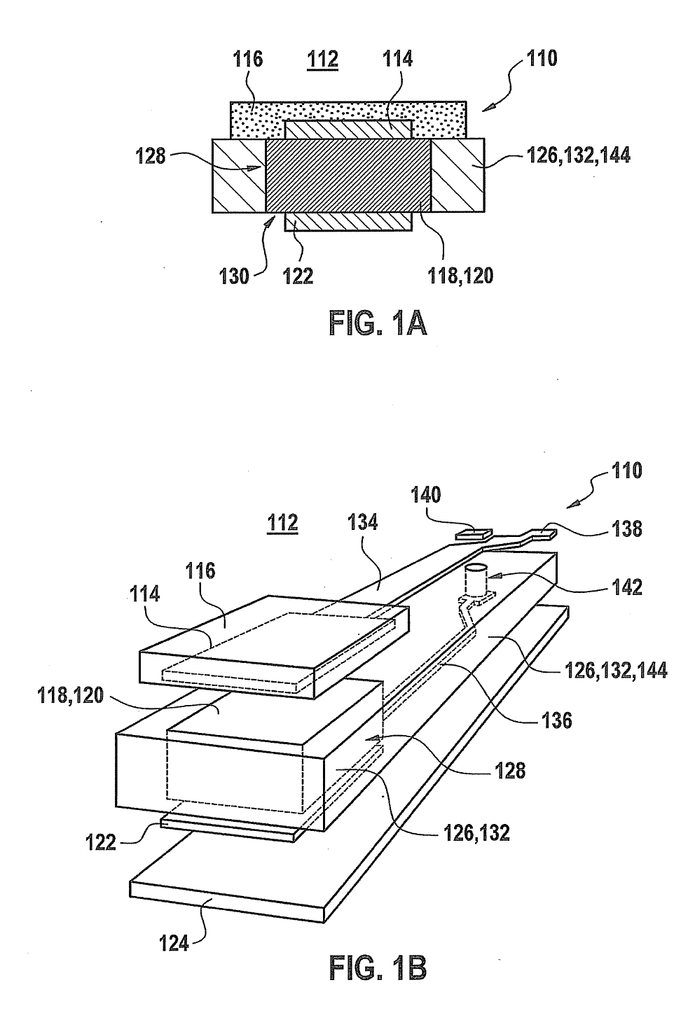

FIGS. 1A and 1B show a first exemplary embodiment of sensor element 110. FIG. 1A shows a schematic cross-sectional representation whereas FIG. 1B shows a representation in perspective of the layered structure of sensor element 110. Furthermore sensor element 110 may include other elements not shown in FIGS. 1A and 1B. Sensor element 110 includes a first electrode 114, which in this exemplary embodiment is in the form of an outer electrode and may be exposed to the gas from the measuring gas chamber 112 after it has passed through a protective layer 116. As an example, a highly porous ceramic material, for example aluminum oxide, may be used for protective layer 116. Furthermore, sensor element 110 includes a solid electrolyte 118 made of a material 120. This solid electrolyte material 120 may be zirconium dioxide as the matrix material, doped with scandium oxide. In principle, however, other oxygen-conductive materials which are compatible with the rest of the layered structure may also be used.

On the side of solid electrolyte 118 opposite to first electrode 114, which forms the outer electrode, a second electrode 122 is situated. This second electrode 122 may be situated, for example, in the interior of a layered structure, so that further layers may be connected below second electrode 122. This is indicated in FIG. 1B by means of an optional base layer 125, which is not shown in FIG. 1A and which for example may take the form of a simple covering layer. More complex layer structures are also conceivable. Furthermore, as an option, this base layer 124 may contain several layers, so that, for example, a heating element may be incorporated in this base layer 124. For simple applications, such as those for motorcycles, this heating element may also be omitted, which is preferable. In the layered structure shown in FIG. 1B, second electrode 122, for example, thus takes the form of an inner electrode. Second electrode 122, located toward the interior, which may also act as a reference electrode, may also be linked to a reference gas chamber. To that end, the layered structure shown in FIG. 1B may additionally contain, for example, one or several reference air ducts, not shown in FIG. 1B, through which second electrode 122 may be exposed to reference air. For example, these may be one or several reference air ducts having a highly porous gas-permeable material, and they may for example be manufactured with the aid of a suitable printing method.

Solid electrolyte material 120 may take the form of a material having a high conductivity for oxygen ions, which may be achieved by appropriate doping using scandium. In that way, a level of oxygen ion conductivity needed for the operation of sensor element 110 may for example be set as low as the temperatures that are customary in the exhaust system of an internal combustion engine, for example a motorcycle, without any need for an additional heating element. For example, this may cover temperatures in the range between ambient and 300° C., for example 100° C. to 200° C. Since an increased doping of solid electrolyte material 120 is in many cases associated with a lower mechanical stability of the material 120, according to the present invention sensor element 110 includes a carrier element 126. The two electrodes 114, 122 and solid electrolyte 118 joining together electrodes 114, 122 together form a cell 128, for example a discrete-level cell and/or a pumping cell. To this end, sensor element 110 may for example provide appropriate drive circuits which cause the cell to operate in that manner. Because of the high level of doping described above, this cell 128 is however usually of a lower mechanical stability than conventional cells used in habitual sensor elements 110. Carrier element 126 accordingly provides mechanical stabilization of this cell 128. To this end, carrier element 126 in the exemplary embodiment shown in FIG. 1A and FIG. 1B takes the form of a planar carrier layer 144, which includes orifice 130, which is in this case rectangularly shaped, for example, in the form of a recessed area. Solid electrolyte 118, for example in the form of a stamped-out piece of foil, may be placed into this orifice 130. Carrier element 126 surrounds solid electrolyte material 120, which for example may be of approximately the same, or alternatively a different, thickness as the material of carrier element 126, and thus takes the form of a frame. This frame may also be completely or partially open at one or more places.

Carrier element 126 incorporates a carrier material 132. As recited above, this carrier material 132 in the exemplary embodiment shown in FIGS. 1A and 1B may be in the form of a layer, for example a layer of a foil material, so that carrier element 126 for example may take the form of carrier layer 144 or may include such a carrier layer 144. Carrier material 132 may for example also include ceramic zirconium oxide, which, however, may have no doping or alternatively only such doping as to cause the oxygen ion conductivity or the ionic conductivity in general of carrier material 132 to be lower than that of solid electrolyte material 120. Alternatively, carrier material 132 may also include for example aluminum oxide, for example Al₂O₃. For example, carrier material 132 may take the form of an aluminum oxide foil. If aluminum oxide of a high degree of purity is used, it will have low ionic conductivity and low electronic conductivity. As an alternative to the use of pure aluminum oxide, however, the aluminum oxide may also contain additives. Thus for example the aluminum oxide may also have ZrO₂ added to it up to just below a percolation limit, in order thereby to achieve, for example, better mechanical characteristics for carrier material 132.

Furthermore, electrode leads 134, 136 are apparent in FIG. 1B. First electrode lead 134 is situated on the side of carrier element 126 facing towards measuring gas chamber 112 and is connected to first electrode 114. First electrode lead 134 ends at a first connection contact 138. Second electrode lead 136, on the other hand, is on the side of carrier element 126 facing away from measuring gas chamber 112 and is connected to second electrode 122 situated towards the interior. A second connection contact 140 is situated on top of carrier element 126, and connected to second electrode lead 136 via a feedthrough 142 penetrating carrier element 126 (not shown completely in FIG. 1B). The design of carrier element 126 as a carrier element with insulating carrier material 132 has the result that the insulation of this feedthrough 142 may be considerably simplified or that such an insulation of feedthrough 142 may be eliminated completely. Also the insulating layers habitually present between electrode leads 134, 136 and solid electrolyte 118 may be completely or partially eliminated, since these electrode leads according to the present invention are essentially situated on material 132 of carrier element 126. Such insulating layers may be provided only in the areas in which, as heretofore, these electrode leads 134, 136 run completely or partially on the actual solid electrolyte material 120, while in the remaining areas these insulating layers may be eliminated, owing to the insulating properties of carrier material 132.

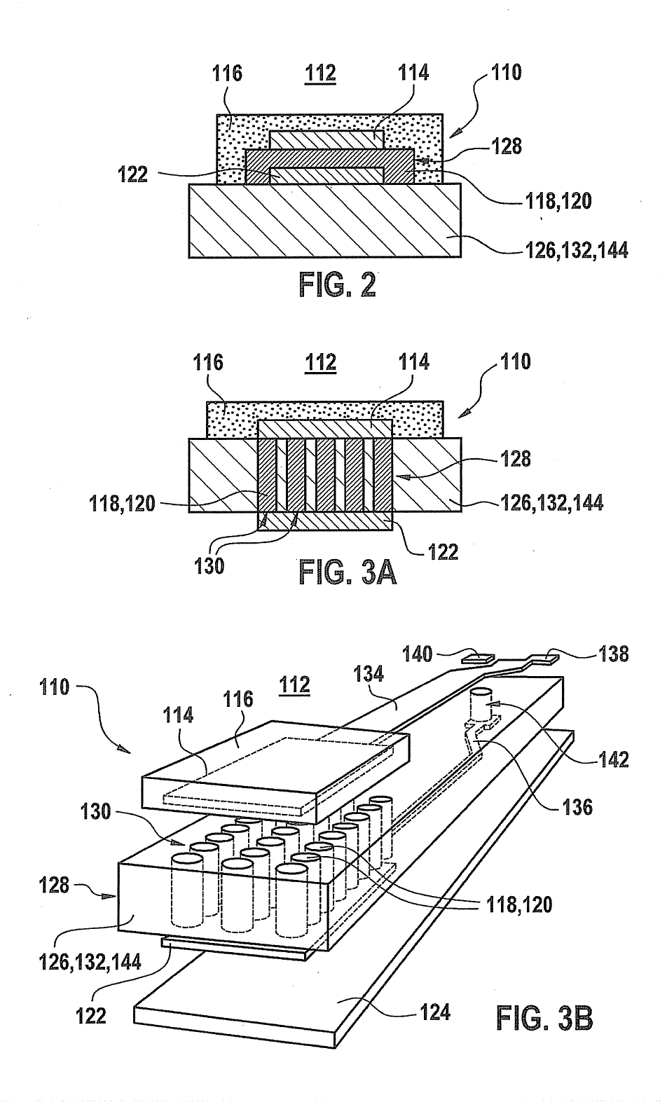

FIG. 2 shows, in a representation similar to FIG. 1A, a second exemplary embodiment of a sensor element 110 according to the present invention. Once again this sensor element 110 includes a cell 128, which for example may be operated as a discrete-level cell and/or a pumping cell. The cell once again includes a first electrode 114, which may be exposed to gas from measuring gas chamber 112 via an optional porous protective layer 116, a second electrode 122 situated towards the interior and a solid electrolyte 118 made of material 120, joining first electrode 114 and second electrode 122 together. Once again the solid electrolyte material may for example include zirconium dioxide as the matrix material and may include one or more oxides of what may be a divalent or trivalent metal, for example scandium. In this way, solid electrolyte material 120 may be made to have a higher oxygen ion conductivity than habitual solid electrolyte materials.

Once again sensor element 110 as shown in FIG. 2 has a carrier element 126. By contrast with the exemplary embodiment as shown in FIGS. 1A and 1B this carrier element in the present case is not designed in the form of a frame, but of a continuous carrier layer 144, upon which cell 128 is placed. Installation of the individual components of cell 128 may for example be by means of board-printing methods, laminating or similar layer-handling technologies. Carrier layer 144 includes once again a carrier material 132. For example, this may once again be one or more of the carrier materials described above with reference to the exemplary embodiment in FIGS. 1A and 1B. Sensor element 110 as a whole may be constructed in a similar manner to that shown in FIG. 1B. Thus for example electrodes 114, 122 may once again be connected to corresponding electrode leads 134, 136, which however in this case may be situated on the same side of carrier element 126. Also in this case, insulation between electrode leads 134, 136 and carrier element 126 may once again be eliminated, since this carrier element 126 may be manufactured from an electrically insulating material. Feedthroughs 142 may also be eliminated.

Furthermore, sensor element 110 as in FIG. 2 may contain additional elements, for example once again one or more reference air ducts, not shown in FIG. 2. With the aid of this or these reference air duct(s) once again second electrode 122, which in this case may act as a reference electrode, may be exposed for example to a gas mixture of a known composition, for example ambient air, in order to thereby generate a known electrode potential at this second electrode 122. Also, if cell 128 is designed as a pumping cell, a reference air duct of this type may be used, for example, to guarantee an inward or outward flow of oxygen.

FIGS. 3A and 3B show a third exemplary embodiment of a sensor element 110 according to the present invention. This sensor element 110 is largely similar to sensor element 110 according to the exemplary embodiment shown in FIGS. 1A and 1B. In this respect, reference may be made to the description above for the possible designs of this sensor element 110. Once again sensor element 110 includes at least one cell 128 with a first electrode 114 facing towards measuring gas chamber 112, which is covered by a porous protective layer 116 and thereby protected against impurities. Furthermore, sensor element 110 includes a second electrode 122, which for example once again may take the form of an electrode situated towards the interior. This second electrode 122 situated towards the interior, also, may once again be linked with a reference air duct, which is not shown in FIGS. 3A and 3B. The two electrodes 114, 122 are once again linked by a solid electrolyte 118 made of a material 120. With regard to the possible embodiments of the solid electrolyte material 120 reference may be made, for example, once again to the description above.

In addition sensor element 110 includes once again at least one carrier element 126, which confers mechanical stability on the at least one cell 128. Unlike the exemplary embodiment shown in FIGS. 1A and 1B, solid electrolyte 118 is not, however, placed into a single orifice 130, but a plurality of such orifices 130 are present in carrier material 132 of carrier element 126. These orifices 130 may for example be round or polygonal in cross-section and may take the form of bore holes in carrier element 126. The plurality of orifices 130 may for example be situated in the form of a regular or irregular matrix, as is apparent in particular in the representation shown in FIG. 3B. It is preferable if each of these bore holes or orifices 130 is completely filled with solid electrolyte material 120. In this way a highly conductive solid electrolyte material 120, in other words, a material having high oxygen ion-conducting properties, may be placed in a network of filled orifices 130, in which the total filled area provides a sufficiently high total conductivity or current carrying capacity for cell 128. In this way, the mechanical stability, at constant or only slightly worsened total current-carrying capacity, may be markedly increased as a result of the network structure.

The remaining structure of sensor element 110 may largely be like the structure as shown in FIG. 1B. Accordingly, for example a first electrode lead 134, a second electrode lead 136 and at least one feedthrough 142 may once again be provided to connect up with electrodes 114 and 122. Also in this case, insulating layers to protect these elements with respect to carrier material 132 may once again be eliminated, at least to a large extent, since this carrier material 132 may once again be made to be non-conductive or only slightly conductive.

1-12. (canceled)

13. A sensor element (110) for determining at least one property of a gas in a measuring gas chamber (112), in particular for indicating the presence of a gas component in a gas mixture, including at least one cell (128) having at least one first electrode (114), at least one second electrode (122) and at least one solid electrolyte (118) with a solid electrolyte material (120), linking the first electrode (114) and the second electrode (122), wherein the sensor element (110) furthermore has at least one carrier element (126) of a carrier material (132), the carrier material (132) having a lower ionic conductivity than the solid electrolyte material (120), and the carrier element (126) being designed and situated as to confer mechanical stability on the cell (128).

14. The sensor element of claim 13, wherein the carrier material includes a ceramic material.

15. The sensor element of claim 13, wherein the carrier material includes at least one ceramic insulating material.

16. The sensor element of claim 13, wherein the ceramic insulating material includes at least one of the following materials: an aluminum oxide, and Al₂O₃.

17. The sensor element of claim 13, wherein the carrier material includes at least one second solid electrolyte material, the second solid electrolyte material having a lower ionic conductivity than the solid electrolyte material.

18. The sensor element of claim 13, wherein the second solid electrolyte material includes a zirconium oxide.

19. The sensor element of claim 13, wherein the carrier material includes Al₂O₃ to which ZrO₂ has been added.

20. The sensor element of claim 13, wherein the solid electrolyte material includes a doping material, which includes at least one of the following materials: scandium or Sc₂O₃, erbium, ytterbium, yttrium, calcium, lanthanum, gadolinium, europium, and dysprosium.

21. The sensor element of claim 13, wherein the carrier element at least partially takes the form of a frame, the frame at least partially surrounding the cell, including the solid electrolyte.

22. The sensor element of claim 13, wherein the carrier element at least partially takes the form of a carrier layer, the cell being applied on the carrier level by being printed on it.

23. The sensor element of claim 13, wherein the carrier element at least partially takes the form of a carrier layer, the carrier layer having at least one orifice, including a plurality of orifices, and wherein the solid electrolyte material is introduced at least partially into the orifice.

24. The sensor element of claim 13, wherein the sensor element has a layered structure having at least two levels of layers, at least one electrical feedthrough being provided, and the electrical feedthrough penetrating through the carrier element.
